(19) United States
(12) Patent Application Publication
(10) Pub. No.: US 2008/0063329 A1
(43) Pub. Date: Mar. 13, 2008

(54) BEARING FIXING STRUCTURES

(75) Inventors: Hideki ASANO, Obu-shi (JP); Hiroshi ASANUMA, Obu-shi (JP); Toshiyuki MASUI, Obu-shi (JP); Hiroshi TANIMURA, Kariya-shi (JP)

Correspondence Address: DENNISON, SCHULTZ & MACDONALD, 1727 KING STREET, SUITE 105, ALEXANDRIA, VA, 22314, US

(73) Assignees: AISAN KOGYO KABUSHIKI KAISHA, Obu-shi (JP); DENSO CORPORATION, Kariya-shi (JP)

(21) Appl. No.: 11/850,166

(22) Filed: Sep. 5, 2007

(30) Foreign Application Priority Data
Sep. 11, 2006 (JP) 2006-245392
Apr. 11, 2007 (JP) 2007-103747

(51) Int. Cl. F16C 35/00

(52) U.S. Cl. 384/428

(57) ABSTRACT

The present invention includes a bearing fixing structure for fixing a bearing in position relative to a resin housing by press-fitting the bearing into a recess formed in the housing. The bearing fixing structure includes a non-contact face formed along the entire inner circumference of the recess of the housing and constructed not to contact with an outer circumferential face of the bearing. Projections are formed on the non-contact face and are arranged along the circumference of the non-contact face. Each projection extends along a press-fitting direction for the bearing, so that the projections can be crushed by the outer circumferential face of the bearing as the bearing is press-fitted into the recess. A sealing face is formed in the recess on the front side of the non-contact face with respect to the press-fitting direction, so that the entire circumference of the outer circumferential face of the bearing can closely contact with the sealing face.

This application claims priority to Japanese patent application serial numbers 2006-245392 and 2007-103747, the contents of which are incorporated herein by reference.

### BACKGROUND OF THE INVENTION

1. Field of the Invention

The present invention relates to structures for fixing bearings, which can rotatably support shafts, relative to resin housings by press-fitting the bearings into recesses formed in the resin housings.

2. Description of the Related Art

Japanese Laid-Open Patent Publication No. 2005-282779 teaches a known bearing fixing structure. In this structure, a ring shaped bearing is press-fitted into a cylindrical tubular recess formed in a resin-molded housing, so that the bearing is fixed in position. This fixing structure can prevent fluid from leaking from between the bearing and an inner circumference of the recess.

In order to enable the bearing to be press-fitted into the recess of the housing, an outer diameter of the bearing is set to be larger than an inner diameter of the recess. The difference between the outer diameter of the bearing and the inner diameter of the recess is called as “press-fitting allowance.” As the press-fitting allowance increases, it is possible to further firmly fix the bearing to the housing. However, a possibility of breakage of the housing during the fitting operation of the bearing may increase. A possibility of breakage of the housing may decrease as the press-fitting allowance decreases. However, a possibility of axial displacement of the bearing due to vibrations that may be transmitted from the shaft may increase.

Therefore, there is a need in the art for a technique that enables a bearing to be firmly fixed to a resin housing by press-fitting and to prevent potential breakage of the housing that may be caused when the bearing is press-fitted into the housing.

### SUMMARY OF THE INVENTION

One aspect according to the present invention includes a structure for fixing a bearing in position relative to a resin housing by press-fitting the bearing into a recess formed in the housing. The structure includes a non-contact face formed along the entire inner circumference of the recess of the housing and constructed not to contact with an outer circumferential face of the bearing. Projections are formed on the non-contact face and are arranged along the circumference of the non-contact face. Each projection extends along a press-fitting direction of the bearing, so that the projections can be crushed by the outer circumferential face of the bearing as the bearing is press-fitted into the recess. A sealing face is formed in the recess on the front side of the non-contact face with respect to the press-fitting direction, so that the entire circumference of the outer circumferential face of the bearing can closely contact with the sealing face.

Because the projections formed on the non-contact face of the recess of the housing are crushed by the outer circumferential face of the bearing, a press-fitting area or a contact area of the bearing can be reduced. Therefore, it is possible to reduce the stress applied to inner circumference of the recess, even if the press-fitting allowance is set to be large. In other words, because the press-fitting allowance can be increased, it is possible to firmly fix the bearing to the housing. Further, because a large press-fitting allowance is possible without substantial increase in the stress applied to the inner circumference of the recess, it is possible to prevent or minimize potential breakage of the housing during the press-fitting operation of the bearing. Furthermore, because the entire circumference of the outer circumferential face of the bearing can closely contact with the sealing face formed in the recess of the housing, it is possible to prevent or minimize potential leakage of fluid between the bearing and the housing.

In one embodiment, each of the outer circumferential face of the bearing and the non-contact face and the sealing face of the recess has a cylindrical configuration. Therefore, the clamping force may be substantially uniformly applied to the bearing along the circumferential direction during the press-fitting operation. As a result, it is possible to prevent or inhibit the bearing from being removed from the housing during a long time use.

The projections may be spaced equally from each other in the circumferential direction of the non-contact face of the recess. With this arrangement, the clamping force may be further uniformly applied to the bearing along the circumferential direction during the press-fitting operation.

Another aspect according to the present invention includes a bearing fixing structure that has a space-defining device and an adhesive agent filled into a space defined by the space-defining device and solidified therewithin. The space can be defined between the inner circumference of the recess of the housing and an outer circumferential face of the bearing when the bearing is press-fitted into the housing. The space is opened at one end in a press-fitting direction of the bearing.

Because the adhesive agent is filled into the space defined between the inner circumference of the recess of the housing and an outer circumferential face of the bearing, it is possible to firmly fix the bearing to the housing even if the press-fitting allowance is set to be small. In other words, because the press-fitting allowance can be reduced, it is possible to reduce the stress that may be applied to the housing, so that potential breakage of the housing during the press-fitting operation can be prevented or minimized.

In one embodiment, the bearing fixing structure further includes a non-contact face formed along the entire inner circumference of the recess of the housing and constructed not to contact with the outer circumferential face of the bearing. First projections are formed on the non-contact face and are arranged along the circumference of the non-contact face. Each projection extends along a press-fitting direction of the bearing. At least one sealing wall connects two adjacent first projections and is positioned on the front side of the fist projections with respect to the press-fitting direction. The non-contact face, the two adjacent first projections, the sealing wall and the outer circumferential face of the bearing define the space for the adhesive agent when the bearing has been press-fitted into the housing.

In another embodiment, a waveform concave-convex structure may be provided on the non-contact face of the recess of the housing, so that the adhesive agent can be applied onto the concave-convex structure. This arrangement can increase an adhesive area, and therefore, the bonding force for fixing the bearing to the housing can be increased.

In a further embodiment, second projections are formed on the inner circumference of the recess of the housing. The second projections are positioned to correspond to opposite ends in the circumferential direction of the opening of the space, so that the second projections can restrict the flow of the adhesive agent in the circumferential direction along the inner circumference of the recess. Therefore, it is possible to effectively use the adhesive agent.

Each of the outer circumferential face of the bearing and the non-contact face of the recess may have a cylindrical configuration. The first projections may be spaced equally from each other in the circumferential direction of the non-contact face of the recess.

In a still further embodiment, a groove or a protrusion is formed on an end face of the bearing on the side of the opening of the space and is disposed about an inner circumferential edge of the bearing. Therefore, even in the event that a part of the adhesive agent has flown out of the space, the adhesive agent may be held in the groove or may be restricted to flow beyond the protrusion. As a result, the adhesive agent may not enter a potential clearance that may be produced between the shaft and the bearing.

In a still further embodiment, an outer circumferential groove is formed in the outer circumferential face of the bearing. The outer circumferential groove communicates with the space that is defined by the space-defining device. Therefore, a part of the adhesive agent filled into the space can flow out of the space into the outer circumferential groove. As a result, it is possible to bond the outer circumference face of the bearing to the inner circumference of the recess of the housing along the circumferential length.

A further aspect according to the present invention includes a combination of a bearing and a resin bearing support. The bearing has an outer circumferential face and an inner circumferential face. The resin bearing support has an axis and defining a recess, so that the bearing can be press fitted into the recess. Projections are formed at a first region of the circumference of the recess, so that the outer circumferential face of the bearing can crush the projections as the bearing is press-fitted into the recess. A contact face is formed at a second region of the circumference of the recess, so that the outer circumferential face of the bearing can closely contact with the contact face when the bearing has been press fitted into the recess of the resin support.

### BRIEF DESCRIPTION OF THE DRAWINGS

FIG. 1 is a horizontal sectional view of a throttle control device incorporating a bearing fixing structure according to a first embodiment of the present invention;

FIG. 2 is a front view of the bearing fixing structure:

FIG. 3 is an enlarged vertical sectional view of the bearing fixing structure as viewed in a direction of arrow III in FIG. 1;

FIG. 4(A) is a vertical sectional view of a bearing support portion of a bore wall portion, which constitutes a part of the bearing fixing structure;

FIG. 4(B) is a vertical sectional view of a bearing, which constitutes a part of the bearing fixing structure;

FIG. 5 is a horizontal sectional view of a throttle control device incorporating a bearing fixing structure according to a second embodiment of the present invention;

FIG. 6 is a front view of the bearing fixing structure:

FIG. 7 is an enlarged vertical sectional view of the bearing fixing structure;

FIG. 8(A) is a vertical sectional view of a bearing support portion of a bore wall portion, which constitutes a part of the bearing fixing structure;

FIG. 8(B) is a vertical sectional view of a bearing, which constitutes a part of the bearing fixing structure;

FIG. 9 is a front view of a bearing fixing structure according to a third embodiment of the present invention:

FIG. 10 is an enlarged vertical sectional view of the bearing fixing structure;

FIG. 11(A) is a vertical sectional view of a bearing support portion of a bore wall portion, which constitutes a part of the bearing fixing structure;

FIG. 11(B) is a vertical sectional view of a bearing, which constitutes a part of the bearing fixing structure;

FIG. 12 is a front view of a bearing structure according to a fourth embodiment of the present invention;

FIG. 13(A) is a vertical sectional view of a bearing support portion of a bore wall portion, which constitutes a part of the bearing fixing structure;

FIG. 13(B) is a vertical sectional view of a bearing, which constitutes a part of the bearing fixing structure;

FIG. 14(A) is a vertical sectional view of a bearing support portion of a bore wall portion, which constitutes a part of a bearing fixing structure according to a fifth embodiment;

FIG. 14(B) is a vertical sectional view of a bearing, which constitutes a part of the bearing fixing structure;

FIG. 15 is a vertical sectional view of a bearing fixing structure according to a fifth embodiment of the present invention; and

FIG. 16 is a front view of a bearing fixing structure according to a sixth embodiment of the present invention.

### DETAILED DESCRIPTION OF THE INVENTION

Each of the additional features and teachings disclosed above and below may be utilized separately or in conjunction with other features and teachings to provide improved bearing fixing structures. Representative examples of the present invention, which utilize many of these additional features and teachings both separately and in conjunction with one another, will now be described in detail with reference to the attached drawings. This detailed description is merely intended to teach a person of skill in the art further details for practicing preferred aspects of the present teachings and is not intended to limit the scope of the invention. Only the claims define the scope of the claimed invention. Therefore, combinations of features and steps disclosed in the following detailed description may not be necessary to practice the invention in the broadest sense, and are instead taught merely to particularly describe representative examples of the invention. Moreover, various features of the representative examples and the dependent claims may be combined in ways that are not specifically enumerated in order to provide additional useful embodiments of the present teachings.

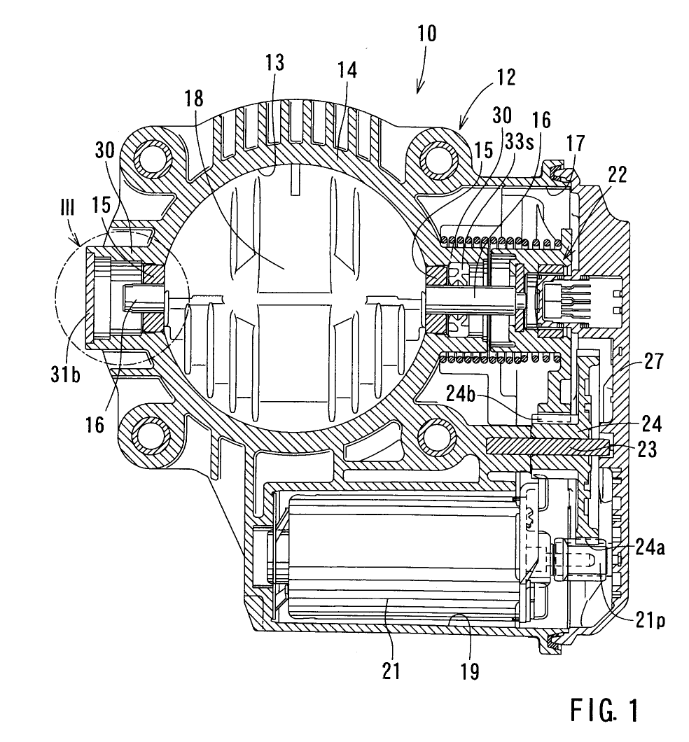

A first embodiment according to the present invention will now be described with reference to FIGS. 1 to 4. Referring to FIG. 1, a throttle control device 10 incorporating a bearing fixing structure according to the first embodiment is shown in a horizontal sectional view.

The throttle control device 10 will now be described in brief. The throttle control device 10 is configured as an electronic control device for controlling the flow of intake air that is supplied to an engine (not shown). The control device is operable in response to the operation of an accelerator pedal that may be located in a driver's cabin of an automobile (not shown).

The throttle control device 10 has a throttle body 12 that can be made of resin, such as PPS (polyphenylene sulfide). As shown in FIG. 1, the throttle body 12 includes a hollow cylindrical tubular bore wall portion 14, a throttle gear housing 17 and a motor housing 19, which are formed integrally with each other. The bore wall portion 14 defines a bore 13 through which the intake air can flow. An air cleaner (not shown) is connected to an upstream-side (front side of the sheet of FIG. 1) of the bore wall portion 14. An intake manifold (not shown) is connected to a downstream-side (backside of the sheet of FIG. 1) of the bore wall portion 14. A circular disk-like throttle valve 18 is disposed within the bore 13 and is rotatable about a central axis for controlling the passage area of the bore 13 for the flow of the intake air. The throttle valve 18 has right and left shaft portions 16, which are respectively disposed on right and left sides of the throttle valve 18 and extend along the central axis of the throttle valve 18. The shaft portions 16 are rotatably supported by respective right and left support portions 30 of the bore wall portion 14 via bearings 15. As described later, the bearings 15 are fixed in position relative to the support portions by press-fitting.

The left shaft portion 16 of the throttle valve 18 extends through the left bearing 15 into the support portion 30 of the bore wall portion 14. The right shaft portion 16 of the throttle valve 18 extends through the right bearing 15 and an oil seal 33s into the support portion 30 and further into the throttle gear housing 17. The throttle gear housing 17 houses a throttle gear 22 configured as a sector gear. The throttle gear housing 17 is positioned on the right side of the bore wall portion 14 to surround the support portion 30 of the bore wall portion 14. Within the throttle gear housing 17, the throttle gear 22 is disposed coaxially with the shaft portions 16 of the throttle valve 18 and is coupled to the right protruding end of the right shaft portion 16, while the throttle gear 22 is prevented from rotating relative to the right shaft portion 16.

The motor housing 19 of the throttle body 12 is adapted to house a motor 21, such as a DC motor, and has a longitudinal axis that is parallel to the shaft portions 16 of the throttle valve 18. The motor housing 19 has a cylindrical tubular configuration with a bottom.

A countershaft 23 is mounted to the throttle body 12 in a position between the throttle gear housing 17 and the motor housing 19 and rotatably supports a counter gear 24. The counter gear 24 has a large-diameter gear portion 24a and a small-diameter gear portion 24b. The large-diameter gear portion 24a is in engagement with a motor pinion 21p of the motor 21. The small-diameter gear portion 24b is in engagement with the throttle gear 22. Therefore, when the motor 21 is driven based on a signal from an engine control unit (not shown) by an amount corresponding to the stepping amount of the accelerator pedal, the rotational torque of the motor 21 is transmitted to the right shaft portion 16 of the throttle valve 18 via the motor pinion 21p, the counter gear 24 and the throttle gear 22. Hence, the throttle valve 18 rotates within the bore 13 to control the amount of flow of the intake air that flows through the bore 13.

A cover 27 is attached to the throttle body 12 for closing the openings of the throttle gear housing 17 and the motor housing 19 of the throttle body 12. The attaching operation of the cover 27 is made after the motor pinion 21p, the counter gear 24 and the throttle gear 22, etc., have been assembled.

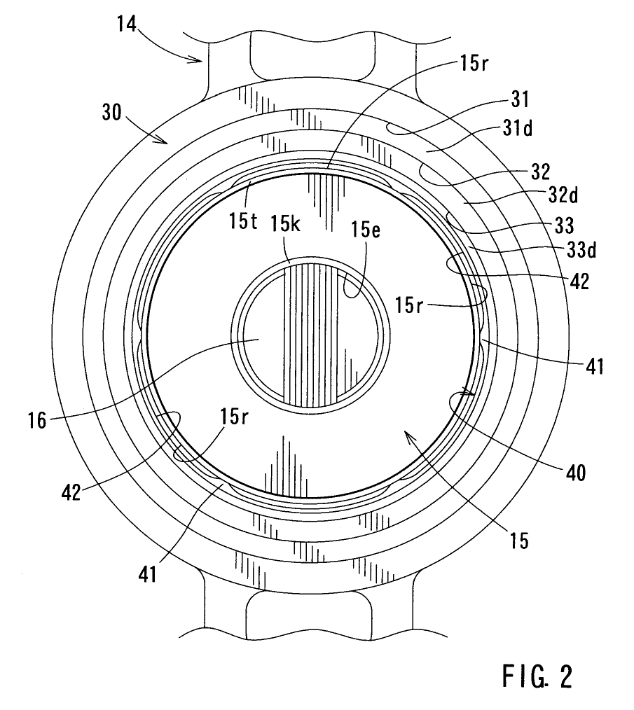

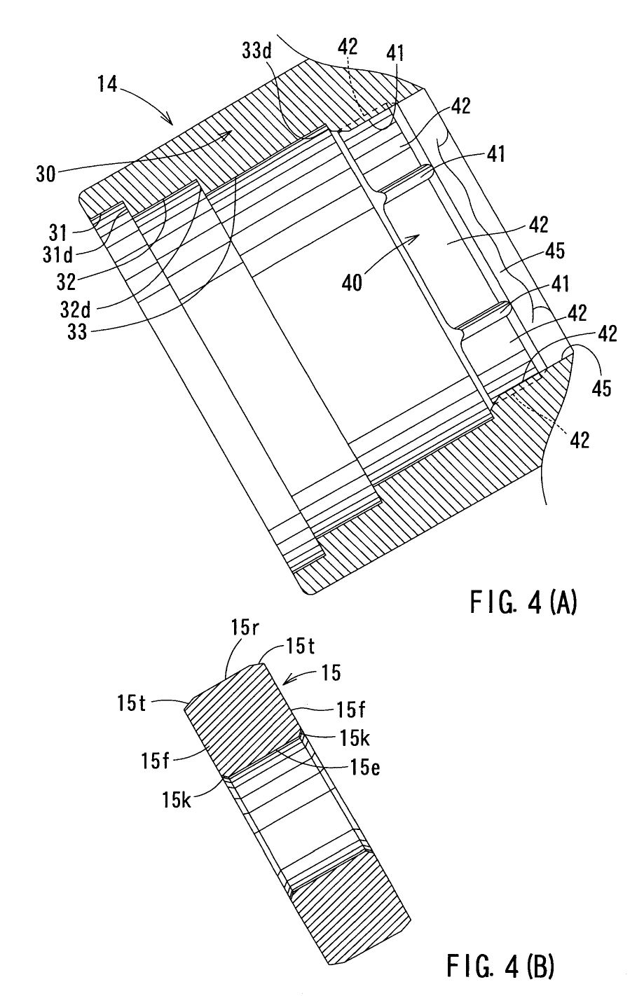

The bearing fixing structure will now be described with reference to FIGS. 2, 3, 4(A) and 4(B). Because the fixing structures of the right and left bearings 15 as well as the configurations of the right and left bearings 15 are the same with each other, only the fixing structure and the configuration of the left bearing 15 will be described. The left bearing 15 is configured as a ring-shaped slide bearing and has a substantially rectangular configuration in cross section as shown in FIG. 4(B). The corners between an outer circumferential face 15r and opposite end faces 15f are chamfered to form tapered faces 15t that are tapered toward the opposite end faces 15f. Also, the corners between an inner circumferential face 15e and the opposite end faces 15f are chamfered to form tapered faces 15k that are enlarged toward the opposite end faces 14f.

The diameter of the inner circumferential face 15r of the bearing 15 is determined such that a predetermined clearance is provided between the inner circumferential face 15r and the corresponding shaft portion 16 of the throttle valve 18. Preferably, machining or cutting a sintered metal forms the bearing 15.

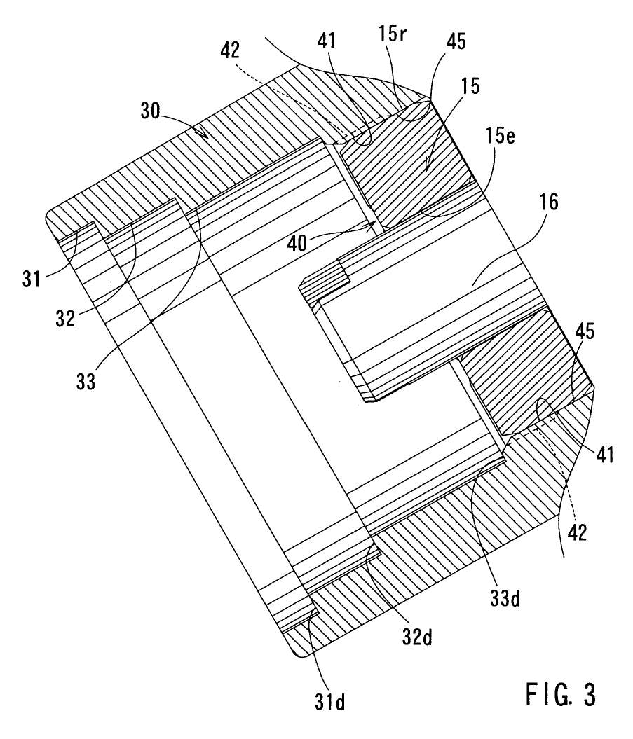

As shown in FIG. 2, 3 and 4(A), the support portion 30 of the bore wall portion 15, into which the bearing 15 is press-fitted, has a substantially cylindrical tubular configuration. A cover receiving recess 31, a space defining recess 32, a seal receiving recess 33 and a press-fitting recess 40 are in turn formed in an inner circumferential wall of the support portion 30 along an axial direction from a front end (left end as viewed in FIGS. 3 and 4(A) and 4(B)) of the inner circumferential wall. The cover receiving recess 31 serves to receive a circular disk-shaped cover 31b (see FIG. 1) for closing the front opening of the support portion 31. The inner diameter of the cover receiving recess 31 is the largest among the inner diameters of the recesses 31, 32, 33 and 40 of the support portion 30. The space defining recess 32 is positioned adjacent to the backside of the cover receiving recess 31 via a ring-shaped stepped portion 31d. The inner diameter of the seal receiving recess 33 is smaller than the inner diameter of the space defining recess 32. The seal receiving recess 33 is positioned adjacent to the backside of the space defining recess 32 via a ring-shaped stepped portion 32d. The seal receiving recess 33 serves to receive a ring-shaped oil seal 33s. The oil seal 33s may be omitted in the case of the left side support portion 30.

The inner diameter of the press-fitting recess 40 is smaller than the inner diameter of the seal receiving recess 33. The press-fitting recess 40 is positioned adjacent to the backside of the seal receiving recess 33 via a ring-shaped stepped portion 33d.

The bearing 15 is press-fitted into the press-fitting recess 40. As shown in FIG. 4(A), the press-fitting recess 40 has a non-contact face 42 and a sealing face 45 positioned on the backside of the non-contact face 42. The non-contact face 42 extends along the entire circumference of the press-fitting recess 40 and the inner diameter of the non-contact face 42 is set to be larger than the outer diameter of the bearing 15, so that the outer circumferential face 15r does not contact with the non-contact face 42 when the bearing 15 has been press-fitted into the press-fitting recess 40. A plurality of projections 41 (six projections 41 are provided in this embodiment as shown in FIG. 2) elongated in the axial direction are formed on the non-contact face 42 and are spaced equally from each other in the circumferential direction. The projections 41 are adapted to be crushed by the outer circumferential face 15r when the bearing 15 has been press-fitted. The height in the radial direction of the projections 41 is determined to provide a large press-fitting allowance.

The sealing face 45 of the press-fitting recess 40 provides a seal between the outer circumferential face 15r of the bearing 15 and the inner circumference of the support portion 30. The inner diameter of the seal surface 45 is determined to be smaller than the outer diameter of the bearing 15.

The press-fitting operation of the bearing 15 is performed according to the following process. First, the bearings 15 are fitted onto the right and left shaft portions 16 in the state where the throttle valve 18 is received within the bore 13 of the throttle body 12 and the right and left shaft portions 16 are inserted into the respective support portions 30 of the bore wall portion 14. Because the tapered faces 15k enlarged toward the end faces 15f are formed at opposite ends of the inner circumferential face 15e of each bearing 15, the operations for inserting the shaft portions 16 of the throttle valve 18 into the corresponding bearings 15 can be facilitated.

Subsequently, with the shaft portions 16 inserted into the respective bearings 15, the bearings 15 are moved axially toward the each other (toward the throttle valve 18) so as to be press-fitted into the press-fitting recesses 40 of the corresponding support portions 30. Because the tapered faces 15t tapered toward the end faces 15f are formed at opposite ends of the outer circumferential face 15r of each bearing 15, the operations for inserting the bearings 15 into the press-fitting recesses 40 can be facilitated.

During the process of press-fitting the bearing 15 into the press-fitting recess 40 of the corresponding support portion 30, the projections 41 formed on the non-contact surface 42 are initially crushed by the outer circumferential face 15r of the bearing 15. Next, after passing through the non-contact surface 42, the leading end of the outer circumferential face 15r of the bearing 15 entirely closely contacts with the sealing face 45, so that the sealing face 45 is forcibly enlarged by the outer circumferential face 15r of the bearing 15. The press-fitting operation is completed when the bearing 15 has been pressed into the press-fitting recess 40 to reach a predetermined position as shown in FIG. 3, so that the bearing 15 can be fixed in position within the press-fitting recess 40.

According to the bearing fixing structure of this embodiment, when the bearing 15 is pressed into the corresponding press-fitting recess 40, the projections 41 formed on the non-contact face 42 of the press-fitting recess 40 are pressed and crushed by the outer circumferential face 15r of the bearing 15. Therefore, the press-fitting area can be reduced, and the stress that may be applied to the support portion 30 at the press-fitting recess 40 can be reduced, even in the event that the press-fitting allowance has been set to be large. In other words, it is possible to provide a large press-fitting allowance. Therefore, the bearing 15 can be firmly fixed within the corresponding support portion 30. In addition, because the stress that may be applied to the support portion 30 is small even if the press-fitting allowance is large, it is possible to prevent or inhibit the support portion 30 from being broken during the press-fitting operation of the bearing 15.

Because the sealing face 45 is formed with the press-fitting recess 40 of the support portion 30 on the backside of the non-contact face 42 and the outer circumferential face 15r of the bearing 15 entirely closely contacts with the sealing face 45, it is possible to prevent or minimize potential leakage of the fluid from between the bearing 15 and the press-fitting recess 40 of the corresponding support portion 30.

Because the outer circumferential face 15r of each bearing 15 and the non-contact face 42 and the sealing face 45 of the press-fitting recess 40 of each support portion 30 are configured to have cylindrical configurations, a clamping force that may be applied to the bearing 15 during the press-fitting operation is substantially uniform along the circumferential direction. Therefore, the bearing 15 can be prevented from being removed from the corresponding support portion 30 during a long time use.

Because the projections 41 are formed on the non-contact face 42 and are spaced equally in the circumferential direction, a clamping force that may be applied to the bearing 15 during the press-fitting operation is substantially uniform along the circumferential direction also in this respect.

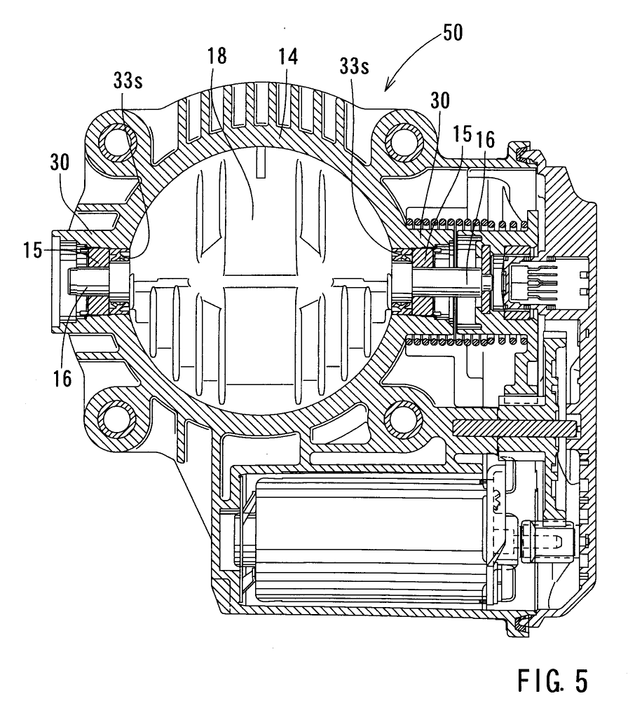

A bearing fixing structure according to a second embodiment of the present invention will now be described with reference to FIGS. 5 to 8. This second embodiment is a modification of the first embodiment. More specifically, the inner circumference of the support portion 30 of the second embodiment is configured such that an adhesive agent can be filled between the press-fitting recess 40 of the support portion 30 and the outer circumferential face 15r of the bearing 15. Therefore, the same bearing 15 can be used in the second embodiment. In FIGS. 5 to 8, like members are given the same reference numerals as the first embodiment, and the description of these elements will not be repeated.

In addition, although the cover 31b of the left bearing 15 and the oil seal 33s of the right bearing 15 are each disposed on the outer side of the corresponding bearing 15 (on the side opposite to the throttle valve 18) in the first embodiment, oil seals 33s are disposed on the inner sides of the right and left bearings 15 in the second embodiment as shown in FIG. 5.

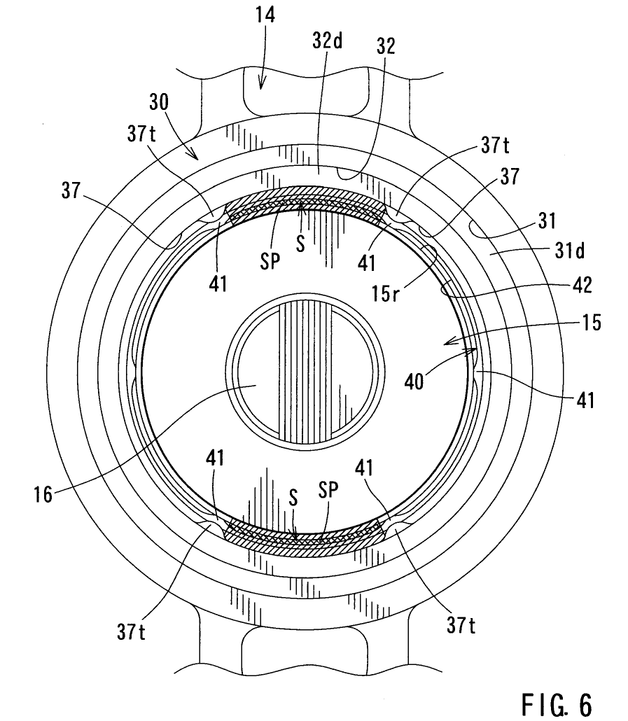

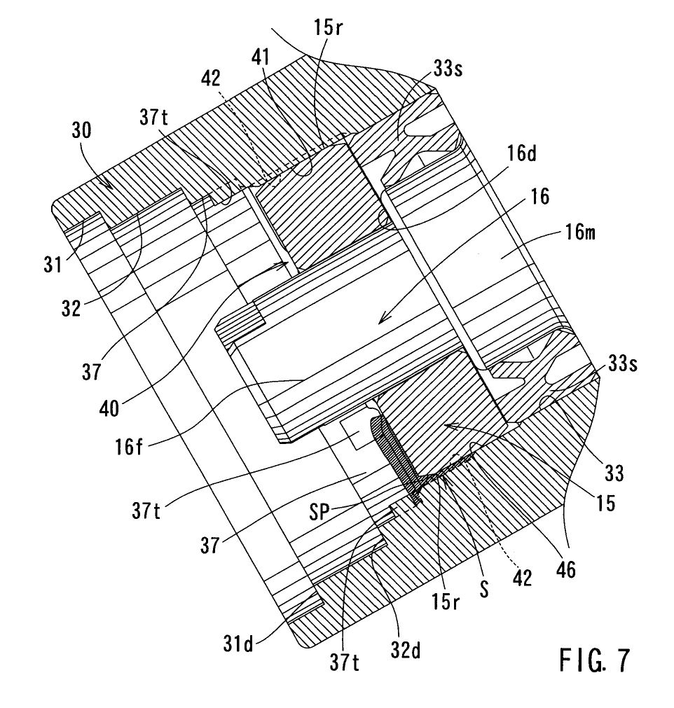

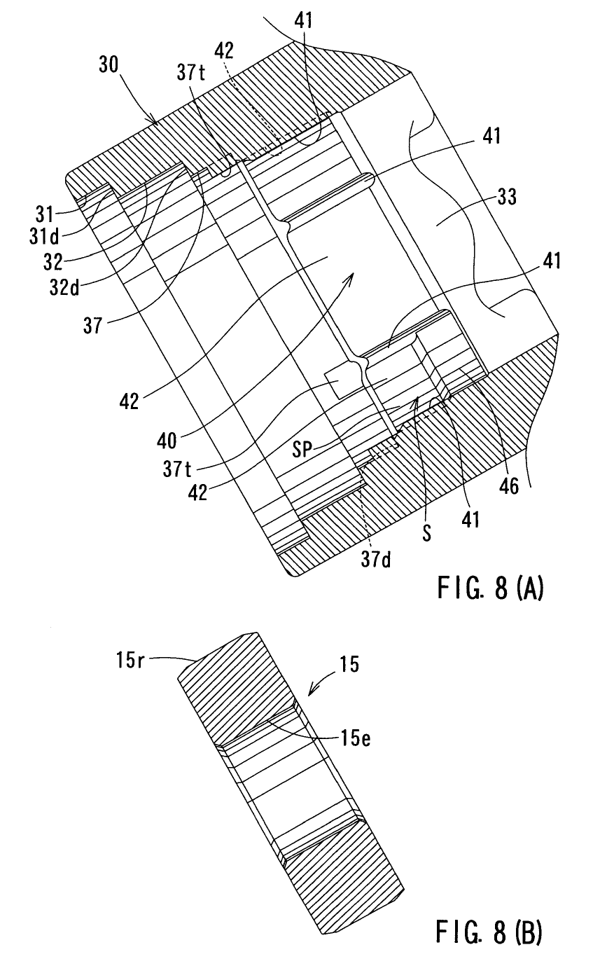

As shown in FIGS. 6, 7 and 8(A), each of the bearing support portions 30 of the bore wall portion 14 is configured to have a substantially cylindrical configuration. The cover receiving recess 31, the space defining recess 32, a recess 37 for preventing an adhesive agent in liquid phase from freely flowing around the inner circumference of the bearing support portion 30, and the press-fitting recess 40 are in turn formed in the inner circumferential wall of the support portion 30 along an axial direction from a front end (left end as viewed in FIGS. 7 and 8) of the inner circumferential wall. The seal receiving recess 33 is formed on the backside (right side as viewed in FIGS. 7 and 8) of the press-fitting recess 40. The cover receiving recess 31 serves to receive the cover 31b (see FIG. 1) that can close the open front end of the support portion 30. The inner diameter of the cover receiving recess 31 is the largest among the inner diameters of the recesses 31, 32, 37, 40 and 33. As noted above, in this embodiment, the oil seal 33s is disposed on the inner side of each bearing 15. Therefore, the cover(s) 31b may be omitted as shown in FIG. 5.

As shown in FIG. 8(A), the space defining recess 32 is positioned adjacent to the backside of the cover receiving recess 31 via the ring-shaped stepped portion 31d. The inner diameter of the recess 37 is smaller than the inner diameter of the space defining recess 32. The recess 37 is positioned adjacent to the backside of the space defining recess 32 via the ring-shaped stepped portion 32d. As will be described later, adhesive agent can be filled into spaces S defined by the press-fitting recess 40. The recess 37 is configured to prevent the adhesive agent from flowing in the circumferential direction along the wall surface of the press-fitting recess 40 out of the spaces S via openings Sp.

Axially extending projections 37t have a relatively short length along the axial direction and are formed on the circumferential wall of the recess 37 at positions (four positions as shown in FIG. 6 in this embodiment) corresponding to opposite circumferential ends of the openings Sp of the spaces S (indicated by the cross-hatching in FIG. 6). The regions indicated by the cross-hatching in FIG. 6 correspond to regions where the adhesive agent is stored.

As shown in FIG. 8(A), the inner diameter of the press-fitting recess 40 is smaller than the inner diameter of the recess 37. The press-fitting recess 40 is positioned adjacent to the backside of the recess 37 via a ring-shaped stepped portion 37d.

The press-fitting recess 40 serves to receive the bearing 15 and has the non-contact face 42 that extends along the entire circumference of the press-fitting recess 40. The inner diameter of the non-contact face 42 is set to be larger than the outer diameter of the bearing 15, so that the outer circumferential face 15r does not contact with the non-contact face 42 when the bearing 15 has been press-fitted into the press-fitting recess 40. The projections 41 (six projections 41 are provided in this embodiment as shown in FIG. 6) elongated in the axial direction are formed on the non-contact face 42 and are spaced equally in the circumferential direction. The projections 41 are adapted to be crushed by the outer circumferential face 15r when the bearing 15 is press-fitted. The height in the radial direction of the projections 41 is determined to provide a large press-fitting allowance. The projections 41 include two pairs of the projections 41 opposing to each other with respect to the central point of the press-fitting recess 40 and located at the same positions as the short projections 37t with respect to the circumferential direction.

As shown in FIG. 8(A), backside end portions of the two projections 41 in each pair of the projections 41 located at the same positions as the short projections 37t are joined to each other via a sealing wall 46. The sealing wall 46 is configured such that the outer circumferential face 15r of the bearing 15 contacts with the sealing wall 46 in surface-to-surface contact relation when the bearing 15 has been press-fitted. Therefore, after the bearing 15 has been press-fitted into the press-fitting recess 40, the spaces S opening at their end portions on the press-fitting side are defined by the outer circumferential face 15r of the bearing 15, the non-contact face 42 of the press-fitting recess 42, the two pairs of the projections 41, and the sealing walls 46.

The seal receiving recess 33 is positioned adjacent to the backside of the press-fitting recess 40 and serves to receive the oil seal 33s. As shown in FIG. 7, each shaft portion 16 of the throttle valve 18 has a large-diameter base side portion 16m to which the oil seal 33s is attached, a front side portion 16f adapted to be supported by the bearing 15, and a stepped portion 16d provided between the base side portion 16m and the front side portion 16f. Therefore, the press-fitting operation of the shaft portion 16 into the bearing 16, which is performed with the front side portion 16f inserted into the bearing 15, can be stopped at a position of the stepped portion 16d of the shaft portion 16.

The press-fitting operation of the bearing 15 can be performed according to substantially the same process as the first embodiment. Thus, the bearings 15 are first fitted onto the right and left shaft portions 16 in the state where the throttle valve 18 is received within the bore 13 of the throttle body 12 and the right and left shaft portions 16 are inserted into the respective support portions 30 of the bore wall portion 14.

Subsequently, the bearings 15 are moved axially toward the each other (toward the throttle valve 18) so as to be press-fitted into the press-fitting recesses 40 of the corresponding support portions 30.

During the process of press-fitting the bearing 15 into the press-fitting recess 40 of the corresponding support portion 30, the projections 41 formed on the non-contact surface 42 are initially pressed and crushed by the outer circumferential face 15r of the bearing 15. As the bearing 15 is further pressed into the pressing recess 40, the leading end of the outer circumferential face 15r of the bearing 15 contacts with the sealing wall 46 in surface-to-surface contact relation. The press-fitting operation is completed when the bearing 15 has been pressed into the press-fitting recess 40 until the bearing 16 contacts with the stepped portion 16d of the shaft portion 16. In this state, the spaces S, into which the adhesive agent can be filled, are defined on opposite sides with respect to the central point of the press-fitting recess 40 by the outer circumferential face 15r of the bearing 15, the non-contact face 42 of the press-fitting recess 42, the two pairs of the projections 41, and the sealing walls 46 (see the regions indicated by the cross-hatching in FIG. 6).

Thereafter, the adhesive agent is filled into the spaces S and is solidified therewithin, so that each bearing 15 can be fixedly bonded to the circumferential wall of the press-fitting recess 40 of the corresponding support portion 30.

According to the bearing fixing structure of this embodiment, the adhesive agent is filled into the regions between the outer circumferential face 15r of each bearing 15 and the press-fitting recess 40 of the corresponding support portion 30. Therefore, it is possible to firmly fix the bearing 15 in position relative to the support portion 30 even in the event that a press-fitting allowance has been set to be small. Because the press-fitting allowance can be reduced, a potential stress that may be applied to the press-fitting recess 40 of the support portion 30 can be reduced. Therefore it is possible to prevent the support portion 30 from being broken during the press-fitting operation of the bearing 15.

Because the short projections 37t are provided on the circumferential wall of the recess 37 of the support portion 30 at positions on opposite sides with respect to the widthwise direction (circumferential direction) of each opening Sp of the spaces S, it is possible to prevent the adhesive agent to flow out of the spaces S via the openings Sp in the circumferential direction along the inner circumference of the recess 37 after the adhesive agent has been filled into the spaces S. Therefore, the adhesive agent can be effectively filled into the spaces S.

Because the spaces S are opened at the end portions on the press-fitting side, from which the bearing 15 is press-fitted, and the backsides of the spaces S are closed by the sealing walls 46, the adhesive agent will not leak toward the side of the oil seal 33s.

The regions other than the regions defining the spaces S may have axially extending clearances that are formed between the press-fitting recess 40 of the support portion 30 and the outer circumferential face 15r of the bearing 15. However, by virtue of the function of the oil seal 33s, a gas that may be contained within the bore 13 of the throttle body 12 will not leak to the outside via the clearances.

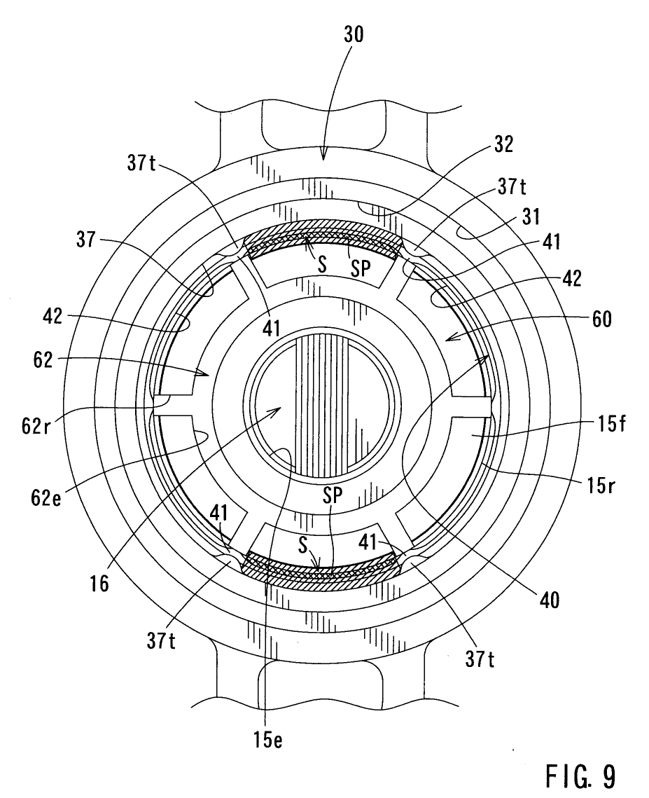

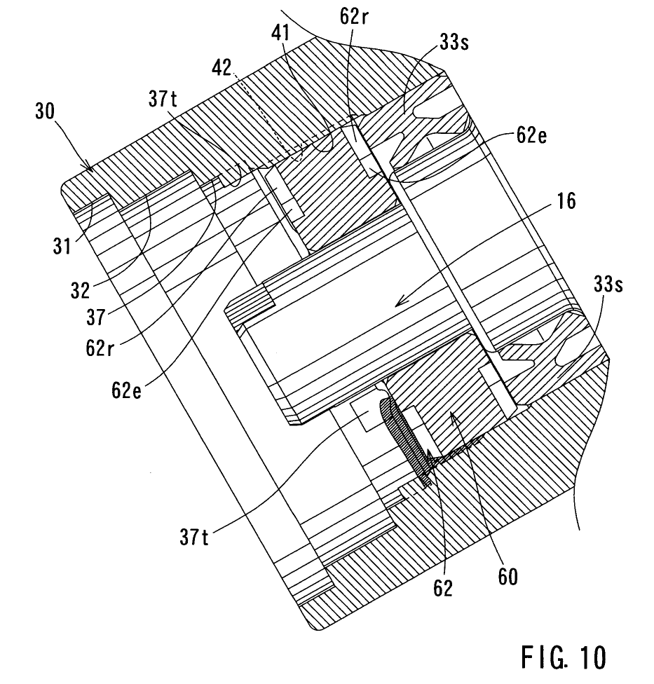

A third embodiment will now be described with reference to FIGS. 9 to 11. This embodiment is a modification of the second embodiment. In particular, the bearings 15 are modified such that the adhesive agent can be prevented from entering between the inner circumferential face 15e of each bearing 15 and the corresponding shaft portion 16 of the throttle valve 18 even in the event that the adhesive agent has been flown out of the spaces S. The construction of the support portion 30 of the third embodiment is the same as the second embodiment. Therefore, like members are given the same reference numerals as the second embodiment and the description of these elements will not be repeated.

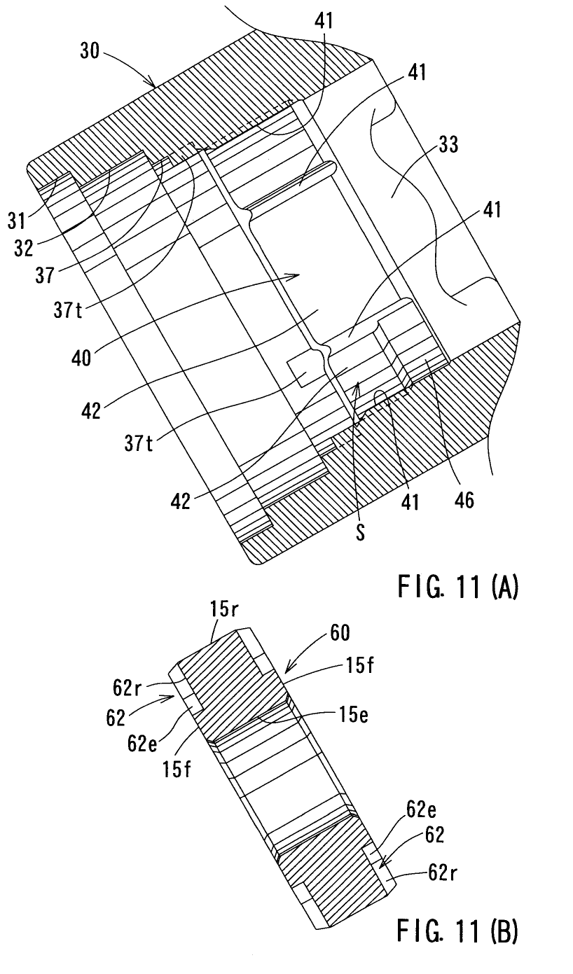

Bearings 60 of this embodiment are different from the bearings 15 of the first and second embodiments in that grooves 62 are formed in opposite end faces 15f of each bearing 60 as shown in FIGS. 9 and 11(B). The remaining construction of the bearings 60 is the same as the bearings 15. Each groove 62 includes an annular groove portion 62e and a plurality of linear groove portions 62r. The annular groove portion 62e is disposed to surround the inner circumferential face 15e of the bearing 60. More specifically, the annular groove portion 52e is coaxial with the inner circumferential face 15e of the bearing 60 and is spaced therefrom. The linear groove portions 62r extend radially outward from the annular groove portion 62e and are positioned to correspond to the positions of the projections 41 of the press-fitting recess 40 of the corresponding support portion 30 (i.e., the positions corresponding to the short projections 37t formed on the circumferential wall of the recess 37) as shown in FIG. 9.

With this arrangement, even in the event that the adhesive agent, which maybe filled into the spaces S after the corresponding bearing 60 has been press-fitted, has flown out of the spaces S via the openings Sp to further flow along the end faces 15f of the bearing 60, the adhesive agent may enter the linear groove portions 62r or the annular groove portion 62e and may be held therein. Therefore, the adhesive agent may not enter between the inner circumferential face 15e of the bearing 60 and the shaft portion 16 of the throttle valve 18.

Although liner groove portions 62r and the annular groove portion 62e are formed in the end faces 15f of the bearing 60 in this embodiment, the liner groove portions 62r may be replaced with linear projections and the annular groove portion 62e may be respectively replaced with an annular projection. In addition, the configurations of the grooves or the projections may be suitable modified.

Although the linear groove portions 62r and the annular groove portion 62e are formed in both of the end faces 15f of the bearing 60, these grooves 62r and 62e may be formed only one of the end faces 15f that is positioned on the same side as the openings Sp of the spaces S.

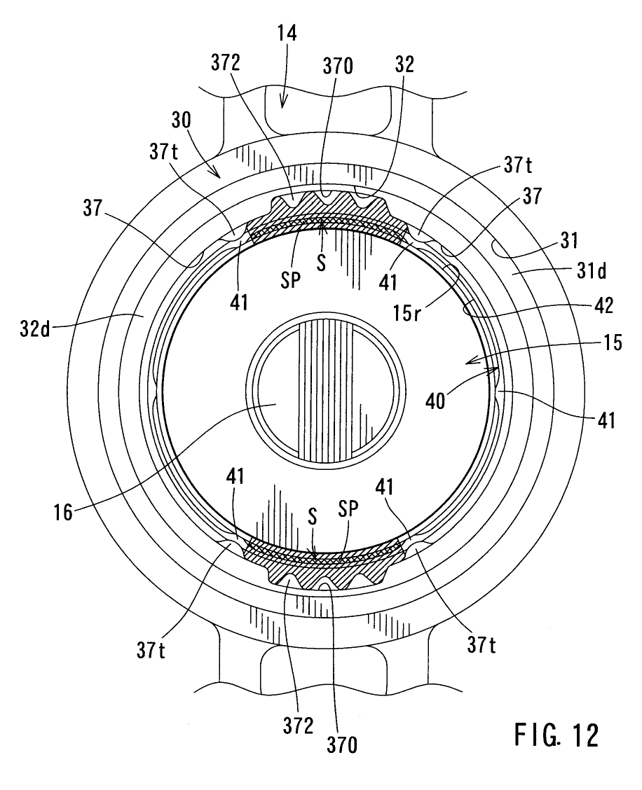

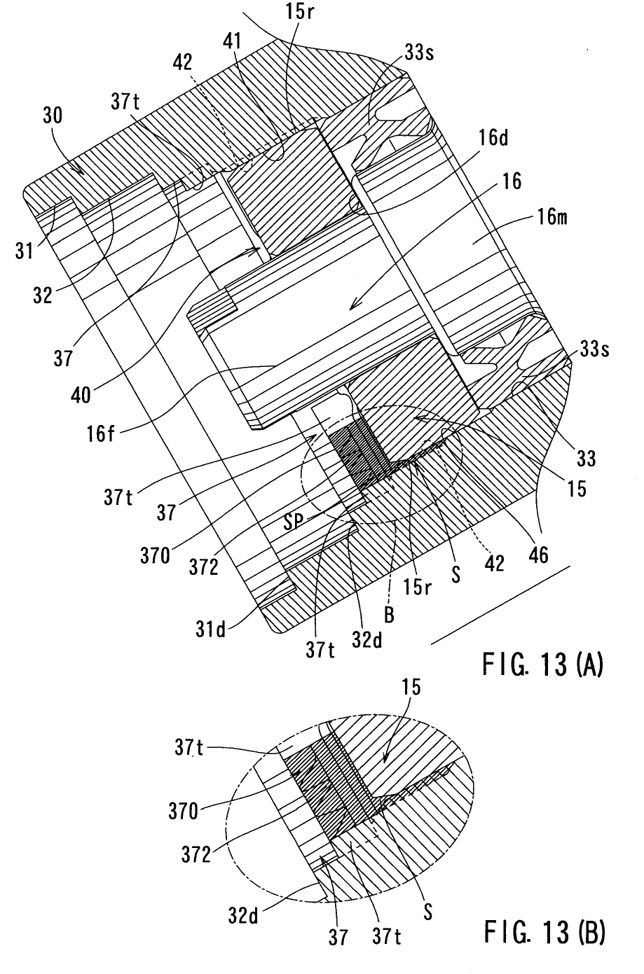

A fourth embodiment will now be described with reference to FIGS. 12 and 13. This embodiment is a modification of the second embodiment. In particular, the recess 37 formed in the inner circumference of the bearing support portion 30 for preventing or restricting the flow of the adhesive agent is modified. The other construction is the same as the second embodiment. Therefore, like members are given the same reference numerals as the second embodiment and the description of these elements will not be repeated.

As described in connection with the second embodiment, the recess 37 serves to prevent the adhesive agent, which may be filled into the spaces S, from flowing out of the spaces S in the circumferential direction along the wall surface via the openings Sp. The short projections 37t are formed on circumferential wall of the recess 37 at positions corresponding to opposite circumferential ends of the openings Sp of the spaces S (indicated by cross-hatching in FIG. 12). The regions indicated by the cross-hatching in FIG. 6 correspond to regions where the adhesive agent is stored. A depression 370 having a uniform depth is formed between two short projections 37t that are positioned to correspond to opposite circumferential ends of each opening Sp. The depression 370 has a substantially arc-shaped configuration and extends along the corresponding opening Sp. A series of protrusions 373 elongated in the axial direction and having a waveform configuration in cross section are formed on the radially inner wall of the depression 370. As shown in FIG. 13(B), the width in the circumferential direction of each protrusion 373 gradually decreases along a direction toward the opening Sp of the corresponding space S.

With this configuration, in the event that a part of the adhesive agent, which is filled into the spaces S, has flown out of the spaces S via the openings Sp, the part of the adhesive agent may enter between two short projections 37t corresponding to each opening Sp. In other words, the part of the adhesive agent may enter each depression 370 and may be held therein (see the shaded region in FIG. 13). As described above, a series of axially elongated protrusions 373 having a waveform configuration in cross section are formed on the radially inner wall of the depression 370, so that troughs are defined between protrusions 373. In other words, a concave-convex structure is formed on the inner wall of the depression 370. Therefore, it is possible to increase the adhesive area and to eventually increase the bonding force of the adhesive agent.

Although a series of protrusions 373 having a waveform cross section are formed on the readially inner wall of the recess 37 of each support portion 30 in the above embodiment, it is possible to provide a similar concave-convex structure, which may be a fine concave-convex structure, on the radially inner surface of the press-fitting recess 40.

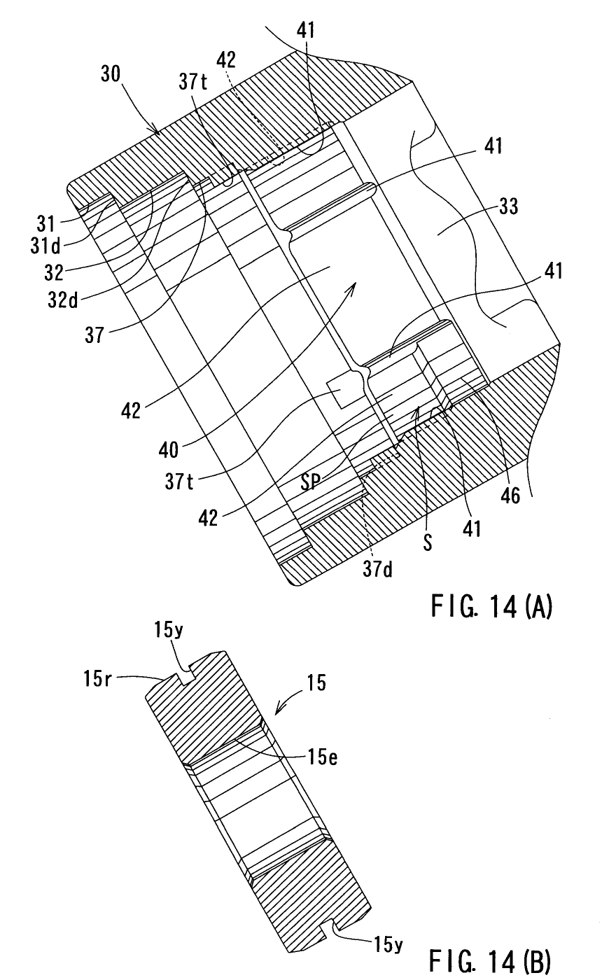

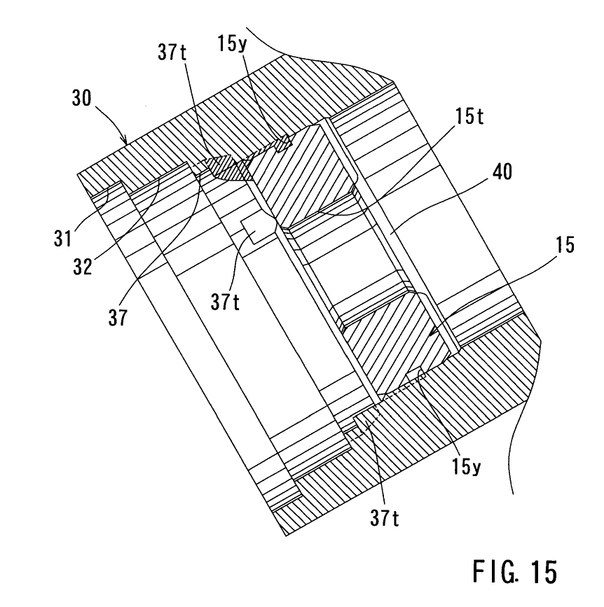

A fifth embodiment will now be described with reference to FIGS. 14 and 15. This embodiment is a modification of the second embodiment. In particular, the bearings 15 are modified to enable the adhesive agent, which is stored within the spaces S, to be guided to the outer circumferential face 15r of the bearings 15. The construction of the support portion 30 of the fifth embodiment is the same as the second embodiment. Therefore, like members are given the same reference numerals as the second embodiment and the description of these elements will not be repeated.

As shown in FIG. 14(B), the bearing 15 of this embodiment has an annular outer circumferential groove 15y formed in the outer circumferential face 15r and positioned at a substantially the central position with respect to the widthwise direction (axial direction) of the outer circumferential face 15r. In order to facilitate the flow of the adhesive agent, the outer circumferential groove 15y has a square or a rectangular cross section as shown in FIG. 14(B). Alternatively, the outer circumferential groove 15y may have a semi-circular cross section.

With this arrangement, the spaces S for receiving the adhesive agent are defined by the bearing 15 when the bearing 15 has been press-fitted into the press-fitting recess 40 of the support portion 30 as in the second embodiment. However, the spaces S are in communication with the outer circumferential groove 15y formed in the bearing 15. Therefore, a part of the adhesive agent filled into the spaces S may flow out of the spaces S into the outer circumferential groove 15y. Therefore, the outer circumferential face 15r of the bearing 15 can be bonded to the radially inner wall of the press-fitting recess 40 along the entire circumferential length.

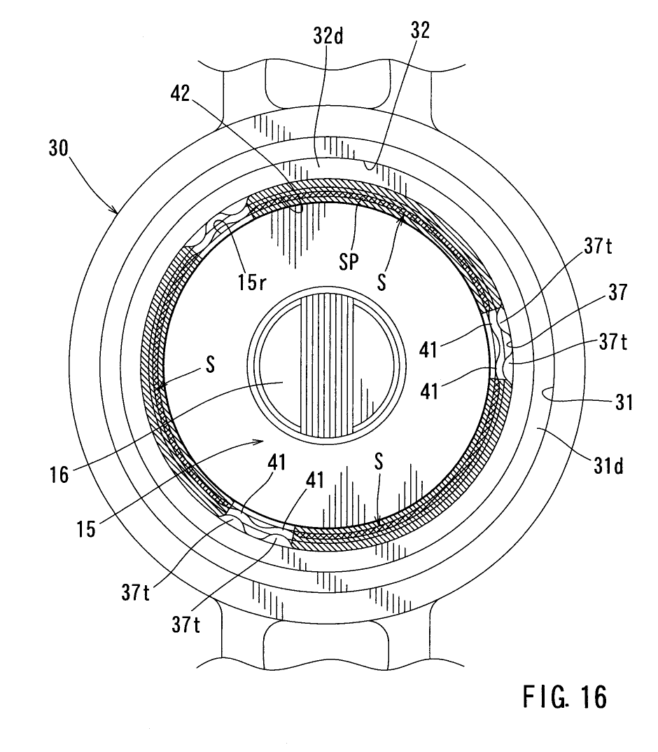

A sixth embodiment will now be described with reference to FIGS. 16. This embodiment is a modification of the second embodiment. In particular, the bearing support portion 30 is modified such that the openings Sp of the spaces S have a large width. The other construction is the same as the second embodiment. Therefore, like members are given the same reference numerals as the second embodiment and the description of these elements will not be repeated.

As shown in FIG. 16, at intervals of an angle of about 120°, three pairs of the projections 41 and three pairs of the short projections 37t are respectively formed on the radially inner wall of the press-fitting recess 40 and the radially inner wall of the recess 37 for preventing or restricting the adhesive agent from freely flowing in the circumferential direction.

The spaces S for receiving the adhesive agent are defined when the bearing 15 has been press-fitted into the press-fitting recess 40 of the support portion 30 as in the second embodiment. Each space S is delimited with respect to the circumferential direction by the corresponding pair of the projections 41 and the corresponding pair of the short projections 37t. Therefore, each space S extends over the circumferential range or the width of an angle of about 120°. Hence, the adhesion area can be enlarged to increase the bonding force. In addition, because each space S is delimited in the circumferential direction by the corresponding pair of the projections 41 and the corresponding pair of the short projections 37t, the adhesive agent filled into one of the spaces S and the adhesive agent filled into the other of the spaces S will not flow to be joined to each other in the circumferential direction. Therefore, it is possible to prevent a potential cold breakage of the solidified adhesive agent, which may be caused if the adhesive agent filled into the one of the spaces S and the adhesive agent filled into the other of the spaces S have been joined to each other in the circumferential direction.

The present invention may not be limited to the above embodiments but may be modified in various ways. For example, although the outer circumferential face 15r of each bearing 15(60) of the bearing fixing structures according to the first to sixth embodiments has a cylindrical configuration, the outer circumferential face 15r may have a different configuration from a cylindrical configuration. Although the first to sixth embodiments have been described in connection with fixing structures for the bearings 15(60) that are configured as slide bearings, the present invention also may be applied to fixing structures for different types of bearings, such as rolling bearings. Although six projections 41 are formed on the non-contact face 42 of the press-fitting recess 40 of each support portion 30 in the above embodiments, the number of the projections 41 may not be limited to six but may be suitably determined.

In the second and third embodiments, only the pairs of the projections 41 defining the spaces S for receiving the adhesive agent are respectively connected by the sealing walls 46. However, a single sealing wall extending along the entire circumference in the same manner as the sealing face 45 of the first embodiment can be provided.

Although the projections 41 formed on the non-contact face 42 of the press-fitting recess 40 have a uniform radial height along the length in the axial direction in the first to sixth embodiments, the height of the projections 41 may vary along the length in the axial direction, if an adhesive agent is not used as in the case of the first embodiment.

Although the first to sixth embodiments have been described in connection with bearing fixing structures used for shaft portions 16 of the throttle valve 18, the present invention also can be applied to bearing fixing structures that are used for various kinds of rotary machines or apparatus other than the throttle control device.

This invention claims:

1. A structure for fixing a bearing in position relative to a resin housing by press-fitting the bearing into a recess formed in the housing, comprising:
a non-contact face formed along the entire inner circumference of the recess of the housing and constructed not to contact with an outer circumferential face of the bearing;
projections formed on the non-contact face and arranged along the circumference of the non-contact face, wherein each projection extends along a press-fitting direction of the bearing, so that the projections can be crushed by the outer circumferential face of the bearing as the bearing is press-fitted into the recess; and
a sealing face formed on the inner circumference of the recess on the front side of the non-contact face with respect to the press-fitting direction, so that the entire circumference of the outer circumferential face of the bearing can closely contact with the sealing face.

2. The structure as in claim 1, wherein each of the outer circumferential face of the bearing and the non-contact face and the sealing face of the recess has a cylindrical configuration.

3. The structure as in claim 2, wherein the projections are spaced equally from each other in the circumferential direction of the non-contact face of the recess.

4. A structure for fixing a bearing in position relative to a resin housing by press-fitting the bearing into a recess formed in the housing, comprising:
a space-defining device constructed to define a space between the inner circumference of the recess of the housing and an outer circumferential face of the bearing when the bearing is press-fitted into the housing, wherein the space is opened at one end in a press-fitting direction of the bearing; and
an adhesive agent filled into the space.

5. The structure as in claim 4, further comprising:
a non-contact face formed along the entire inner circumference of the recess of the housing and constructed not to contact with the outer circumferential face of the bearing;
first projections formed on the non-contact face and arranged along the circumference of the non-contact face, wherein each first projection extends along a press-fitting direction for the bearing,
at least one sealing wall connecting two adjacent first projections and positioned on the front side of the fist projections with respect to the press-fitting direction;
wherein the space is defined by the non-contact face, the two adjacent first projections, the sealing wall and the outer circumferential face of the bearing when the bearing has been press-fitted into the housing.

6. The structure as in claim 4, further comprising a waveform concave-convex structure provided on the non-contact face of the recess of the housing, wherein the adhesive agent can be applied onto the concave-convex structure.

7. The structure as in claim 4, further comprising second projections formed on the inner circumference of the recess of the housing, wherein the second projections are positioned to correspond to opposite ends in the circumferential direction of the opening of the space, so that the second projections can restrict the flow of the adhesive agent in the circumferential direction along the inner circumference of the recess.

8. The structure as in claim 5, wherein each of the outer circumferential face of the bearing and the non-contact face of the recess has a cylindrical configuration.

9. The structure as in claim 5, wherein the first projections are spaced equally from each other in the circumferential direction of the non-contact face of the recess.

10. The structure as in claim 4, further comprising a groove or a protrusion formed on an end face of the bearing on the side of the opening of the space and disposed about an inner circumferential edge of the bearing.

11. The structure as in claim 4, further comprising an outer circumferential groove formed in the outer circumferential face of the bearing, wherein the outer circumferential groove communicates with the space that is defined by the space-defining device.

12. A combination comprising:
a bearing having an outer circumferential face and an inner circumferential face; and
a resin bearing support having an axis and defining a recess, so that the bearing can be press fitted into the recess;
projections formed at a first region of the circumference of the recess, so that the projections can be crushed by the outer circumferential face of the bearing as the bearing is press-fitted into the recess; and
a contact face formed at a second region of the circumference of the recess, so that the outer circumferential face of the bearing can closely contact with the contact face when the bearing has been press fitted into the recess of the resin support.

13. The combination as in claim 12, wherein:
the second region is sized to be slightly smaller than a diameter of the outer circumferential face of the bearing, so that the bearing can be press-fitted into the second region;
the first region has a diameter larger than the second region, so that a clearance is formed between the bearing and the first region of the recess when the bearing has been press-fitted into the second region;
wherein the projections are disposed at the first region of the recess;
wherein the projections have a length in the axial direction of the bearing support and are spaced from each other in the circumferential direction of the recess, so that the clearance is divided into a plurality of space sections along the circumferential direction when the bearing has been press-fitted into the second region.

14. The combination as in claim 12, wherein the first region and the second region are displaced from each other in the axial direction of the recess.

15. The combination as in claim 12, further comprising an adhesive agent filled into any of the space sections and is solidified to bond the bearing to the bearing support at the second region.

16. The combination as in claim 13, wherein the contact face of the first region comprises a plurality of sealing walls spaced from each other in the circumferential direction, and wherein the sealing walls have axial ends delimiting the space sections from one side in the axial direction.
